(19) United States
(12) Patent Application Publication
(10) Pub. No.: US 2012/0124622 A1
(43) Pub. Date: May 17, 2012

(54) SYSTEM AND METHOD OF RENDERING ADVERTISEMENTS BY EMPLOYING PAUSED SCREEN OF TELEVISION

(76) Inventor: Yang Pan, Shanghai (CN)

(21) Appl. No.: 13/358,510

(22) Filed: Jan. 25, 2012

Related U.S. Application Data
(62) Division of application No. 12/239,634, filed on Sep. 26, 2008.

(51) Int. Cl. H04N 21/458; H04N 5/44

(52) U.S. Cl. 725/34; 348/734; 348/E05.096

(57) ABSTRACT

Methods are disclosed for delivering targeted advertisements to a user using a television system including a remote control device. Embodiments for identifying a user from a group of users are disclosed. One embodiment is disclosed by utilizing a remote control with a plurality numeric buttons for selecting a channel and also for identifying a user.

### CROSS-REFERENCE TO RELATED APPLICATIONS

The application is a division of the U.S. patent application Ser. No. 12/239,634, submitted on Sep. 26, 2008.

### BACKGROUND

1. Field of Invention

This invention relates generally to advertising. More specifically, the invention relates to method and system for providing advertisements by employing paused screen of a television terminal, which is a part of the Internet based information retrieval system.

2. Description of Prior Art

Advertising using traditional media, such as television, radio, newspapers and magazines, is well known. Unfortunately, even when armed with demographic studies and entirely reasonable assumptions about the typical audience of various media outlets, advertisers recognize that much of their advertisement budget is simply wasted. Moreover, it is difficult to identify and eliminate such waste. Advertising over more interactive media had become popular. The Internet, and particularly, World Wide Web (Web), has experienced tremendous growth during recent years. The Web allows users to retrieve and access text, graphics, audio, video, and other information from remote servers. As for delivering commercial information to a user using the Internet, it has been found that advertisement in Web pages are most effective if they can be tailored and directed to segments of the population that are likely to be interested in advertised products and services. Because of the interactive nature of the Internet and the ability to easily insert graphical images in Web pages, there have been developed several prior arts to render targeted advertisements to the users.

One of the simplest methods of tailoring Internet advertisements to recipients is similar techniques used in television, radio and other media. In particularly, advertisements are selected to correspond to the subject matter of the Web page or other Internet resources. The U.S. Pat. No. 7,346,606 to Bharat disclosed an art for rendering advertisements to a user by monitoring user behavior and determining the user's topic of interest when the user is assessing the Internet through browsing Web pages.

Among all electronic devices, television is still one of the most popular devices used by various users. Advertisements delivered to viewers through the television are typically broadcasted to the viewers without differentiation, which makes the advertisements less effective. In recent years, there is a trend that television program is delivered by using of communication network rather than more conventional means such as by broadcast and cables. Internet Protocol Television (IPTV) is a system where a digital television service is delivered using Internet Protocol over a network infrastructure such as for example, over a broadband connection. A general definition of IPTV is television content is received by a user through the technologies used for computer networks instead of being delivered through conventional means. More particularly, in IPTV, television programming is delivered as video contents, which is divided into data packets and streamed to consumers over the Internet. The IPTV stream of data packets is received by a set top box, which is connected to a subscriber's television. Typically, the set top box is connected to the Internet over a broadband connection.

IPTV provides greater control and flexibility to consumers than traditional TV distribution technologies. For example, because television programming is delivered point-to-point from a provider to a subscriber, a user may individually control programming being delivered. Also, because television programming is being delivered over the Internet, a user may receive IPTV program from around the world.

In various other digital television delivery systems, such as digital cable and satellite, digital data streams are delivered to a set top box which is connected to a television. These digital television delivery systems can provide various levels of control and flexibility to users.

IPTV and other digital television delivery systems offer greater control to service provider than traditional TV distribution technologies. Service providers can then provide personalized TV advertising. That is, service providers can target specific users or groups of users with customized advertisements based on viewing or purchasing habits of the users. The U.S. Pat. No. 6,463,595 to Hendricks et al disclosed a system to deliver targeted advertisements to different groups of viewers during the commercial breaks to improve the effectiveness of the advertisements. In the U.S. Pat. No. 6,718,551 to Swix et al, a method is disclosed for providing targeted advertisements to a user based upon tracking and storing and analyzing the viewer's selections. In the US patent publication 2007/0291747 by Stern et al, a method is disclosed for user to user targeted advertising using a digital television delivery service. In the U.S. Pat. No. 7,269,837 to Redling et al., an art is disclosed for providing advertisement from a central database server connected to a global computer network to distributed sites via interactive television. A representative icon is presented to a subscriber on a television indicating an advertisement. When the icon is selected, advertisement information details are retrieved from storage in a local memory or from the server and presented to the user. In US patent publication 2006/0031405 by Goldman et al, an art is disclosed for selecting and inserting advertisements in an information documents displayed to a user, wherein the selection is based at least in part on television programming viewed by the user.

All above mentioned prior arts have attempted to deliver targeted advertisements to a user by leveraging programmability of the interactive television. It should be noted that television is a home appliance and is typically shared by multiple family members, who may have different topics of interests. Therefore, it is desirable that the client system including the television terminal and an input device can identify the identity of a user and can deliver targeted advertisements to the user.

Accordingly, it is an object of the present invention to disclose a method to render advertisements to a user by employing an Internet-based information retrieval system including an advertising server and a client system with a computing device, a television terminal and an input device.

It is a further object of the present invention to use the paused screen of the television terminal to deliver the advertisements to the user.

It is still a further object of the present invention to provide means to identity a specific user from a group of users of the system and therefore a targeted advertisement can be delivered to the user.

### SUMMARY OF THE INVENTION

The present invention provides system and method for rendering a targeted advertisement to a user of a television system connected to an advertising server via the Internet through a computing device such as a set top box. Internet Protocol Television (IPTV) is used as an exemplary case in the description, which should not limit the scope of the invention. The present invention applies to systems with various types of digital televisions.

The present invention is based upon the Internet-based information retrieval system including an advertising server operated by an advertisement broker. The broker receives advertisements from advertisers. The advertisers are connected to the server via a communication network, which in many cases is the same network as the one connecting the client systems and the server and in many cases it may be different networks.

The client system comprises of a computing device, a television terminal and an input device which is a remote control in the preferred embodiment. The computing device is typically a set top box, which connects the television terminal and the server via a communication network such as, for example, the Internet. The set top box comprises of a processor, a file storage system and a communication device.

Various embodiments are proposed to identify a user from a group of users of the television system. One embodiment of the present invention utilizes the switching-on screen of the television terminal The screen may be divided into multiple user selectable zones and each of them is associated with a user. The number of zones can be changed according to the number of users. The user selects a zone by actuating the input device. The system receives the signal and recognizes the associated user. Targeted advertisements can then be rendered based upon a stored user profile in the computing device. The user profile, which is stored in the storage system of the computing device, includes but not limits to the user's personal information, the demographic information and the history of the user's selection of TV/video programming as well as the history of the user's selection of advertisements.

In another embodiment, the remote control includes a plurality of programmable input buttons/touch-pads. When a specific button/touch-pad is actuated by the associated user, the system recognizes the user and delivers advertisements accordingly. In one implementation, the buttons/touch-pads may be served as switches for switching on/off the television terminal. In another implementation, the buttons/touch-pads may be served as channel selectors of the television.

Another aspect of the present invention is to use the paused screen of the television system to present the advertisement. When interactive TV is used, a user is able to pause the programming when it is needed. The paused screen typically displays the screen of a video programming at the pausing point till the user resumes the programming after a period of time.

The present invention discloses an embodiment that an advertisement is presented to the user after the computing device receives the signal that the programming is paused. The user has a high chance to view the displayed message before he or she resumes the programming. The resumed programming replaces the displayed advertisement on the screen after receiving the user's instruction. In the same time, the displayed advertisement is redisplayed in a smaller display window on the screen, which is similar to “picture-in-picture” (PIP) that is a popular feature for today's television system.

If the user is intrigued by the displayed message, he or she may select the message for further reviewing in a manner similar to a user selecting a conventional programming shown in the PIP. If the advertisement in PIP is selected, the advertisement is then redisplayed on the screen replacing the video programming. Furthermore, more detailed information of the advertisement may be presented to the user including broadcasting a multi-media programming about the advertisement. On the other hand, the PIP is removed after a predetermined period of time if it is not selected by the user for the further reviewing.

In the preferred embodiment, advertisements are delivered from the advertisement server and are stored in the computing device. In another embodiment, the advertisements are stored in the server and are delivered to the computing device upon the request.

### BRIEF DESCRIPTION OF THE DRAWINGS

For a more complete understanding of the present invention and its various embodiments, and the advantages thereof, reference is now made to the following description taken in conjunction with the accompanying drawings.

FIG. 1 is a schematic diagram of an information retrieval system for rendering advertisements to its users, wherein an advertising server operated by an advertisement broker is connected to a client system through a communication network. The client system includes a computing device, a television terminal and a remote control.

FIG. 2 is a schematic diagram of an embodiment of rendering targeted advertisements illustrating a series of changes of the television terminal from 1) a switching-on screen with multiple user selectable zones associated with users of the system to 2) a screen with a displayed advertisement and to 3) a screen displaying a programming with the advertisement moved into a smaller display window and to 4) a screen with the detailed advertisement messages presented.

FIG. 3 is a schematic diagram of a remote control including a plurality of programmable buttons/touch-pads that are associated with users of the system.

FIG. 4 is a schematic diagram of another embodiment of rendering targeted advertisements illustrating a series of changes of the television terminal from 1) a paused screen of a TV programming to 2) a screen with a displayed advertisement and to 3) a screen displaying the resumed TV programming with the advertisement moved into a smaller display window and to 4) a screen with the detailed advertisement messages presented.

FIG. 5 is a flow diagram illustrating a process that an advertisement is rendered to a user by the use of the switching-on screen of the television terminal of a client system.

FIG. 6 is a flow diagram illustrating a process that an advertisement is rendered to a user by the use of the paused screen of the television terminal of a client system.

FIG. 7 is a flow diagram illustrating a process that a programmable button is programmed to be associated with a specific user.

### DETAILED DESCRIPTION

References will now be made in details to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

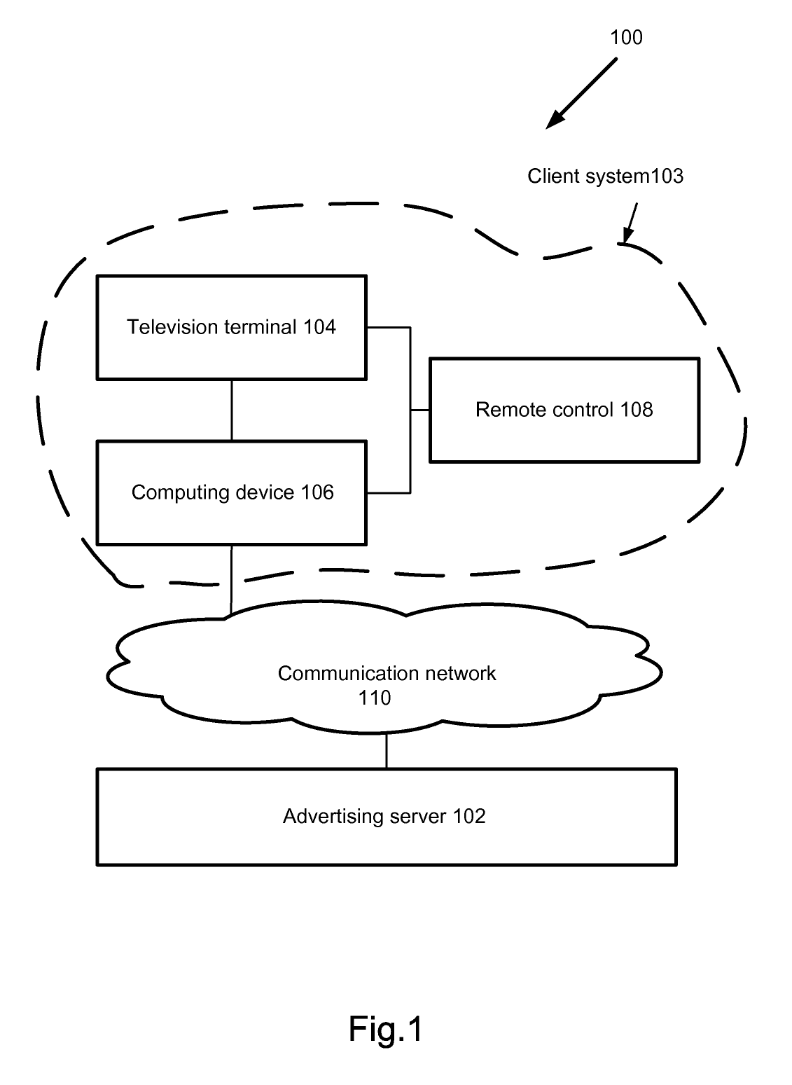

As shown in FIG. 1, the information retrieval system 100 comprises an advertising server 102 operated by an advertisement broker and a client system 103 with a television terminal 104, a computing device 106 and a remote control 108. The computing device 106 of the client system 103 is connected to the server 102 via a communication network 110, which is the Internet in our preferred embodiment. The server 102 is also connected to multiple advertisers who subscribe to the advertisement broker for delivering the advertisements to users of the client systems. The computing device 106 is taken as a set top box in our preferred embodiment. In one implementation of the invention, the computing device 106 is a standalone device connected to the television terminal 104. In another implementation of the invention, the computing device 106 is integrated with the television terminal 104. The computing device 106 includes typically a microprocessor, a file storage system and various communication devices that connect the computing device to the Internet 110, to the remote control 108 and to the television terminal 104. The computing device 106 receives TV programs and advertisements from the server. It stores received information in the storage system and controls the operations of broadcasting programming and displaying advertisements on the television terminal 104.

In various embodiments of the present invention, advertisements may include text, graphics, video, audio and multimedia messages. It should be appreciated that while advertisement messages are used herein as exemplary embodiments of the invention, any document may be used in accordance with the various embodiments. It should be understood that an advertisement as used herein may comprise audio and/or video signals, static and/or dynamic images, graphics, video, film, or other content that relate to one or more products, services, and/or entities, such as commercial entities. Advertisements may also comprise various visual features, including animation, sound etc., and may include text, such as in a text advertisement. Thus, the term “advertisement” is used herein in its broadest sense to include any content or object intended for observation, use, or consumption by one or more persons for the purpose of marketing or promoting a product or service.

Although a single server and a single client system are depicted in FIG. 1 for the purpose of simplicity, the present invention may be based upon a system with multiple servers as well as multiple client systems. In one embodiment, the remote control 108 may communicate to the computing device 106 only and the computing device 106 communicates with the television terminal 104. In another embodiment, the input device 108 may communicate with the television terminal 104 and the computing device 106 concurrently.

The television terminal 104 may be connected to the computing device 106 via a wired connection including an IEEE 1394 type of connection. In an alternative implementation, the terminal 104 may be connected to the computing device 106 via a wireless connection which conforms to various IEEE standards including IEEE 802.11, IEEE 802.15.1 and IEEE 802.15.4 as well as their amendments. The computing device 106 may be connected to the Internet via a wired broadband connection or it may be connected via a wireless broadband connections.

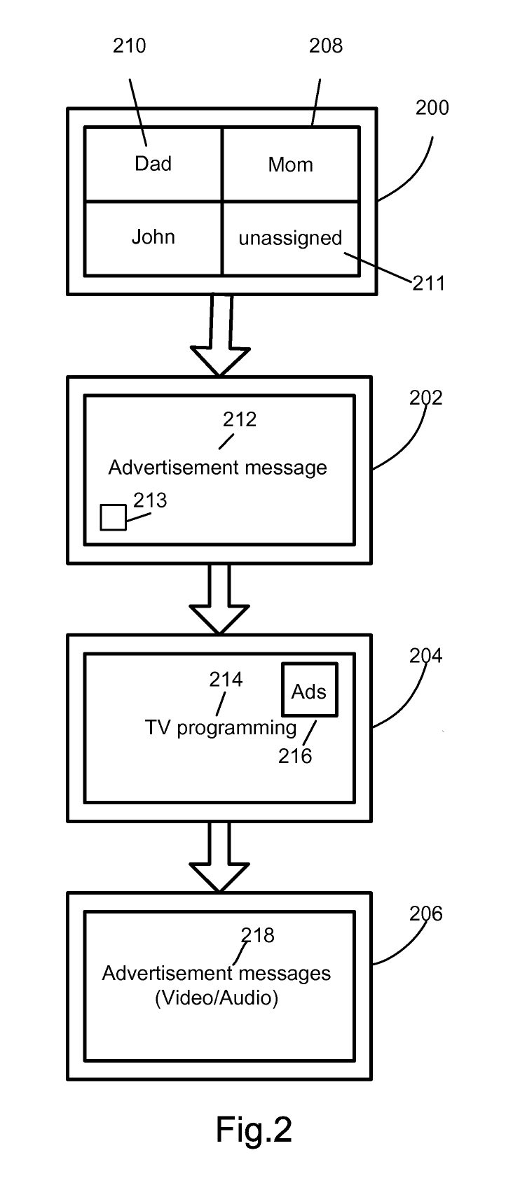

FIG. 2 is a schematic diagram of an embodiment of rendering a targeted advertisement illustrating a series of changes of the television terminal from 200 to 206. The display screen 200 is a switching-on screen with multiple selectable zones (208) associated with each of the users. The users may be represented on the screen with a name or nickname or a visual symbol or their combination (210). The screen may also include a zone 211 which has not been assigned to any user and may be used by anyone. The number of zones is changeable depending on the number of users of the system. In our preferred embodiment, the zone is a rectangular shape. It should be noted that the zone can take any shape as long as it is visible to the user.

In one implementation of the present invention, the user may move a visible symbol on the screen through the manipulation of the remote control to the zone which represents him or her. The visible symbol may be a cursor controllable by the remote control. After the cursor is located in the zone of the choice, the user makes a selection by actuating the remote control. It should be noted that there are different ways to select a zone displayed on the screen as obvious to these familiar with the art. A screen 202 is then displayed with a selected advertisement 212 based upon the user's profile, which is stored in the computing device. A visual symbol 213, which guides the user to re-program the selected zone, is displayed on the screen. The advertisement may take a form as text or graphics to attract the user's attention quickly. The user selects a TV or a video programming by the use of the remote control. In the screen 204, the selected programming 214 is broadcasted while the displayed advertisement 212 is moved into a small display window 216. This is similar to “Picture-In-Picture” (PIP) of today's television system. A remote control of the television has typically a button dedicated to PIP function.

If the user is intrigued by the advertisement, he or she may select the advertisement in the smaller display window 216 for a further viewing as shown in 206. The operation may be achieved by moving the cursor to the smaller window and actuating the input device. The operation may also be executed by actuating the dedicated button for PIP. The re-displayed advertisement 218 may be in the original form of the displayed advertisement. It may also be an expanded version of the advertisement including a programming in video/audio forms for more detailed information.

In our preferred embodiment, the user selectable zones are displayed on the screen of the television terminal concurrently. In another embodiment, the user selectable zones may be displayed on the screen one by one in a sequential manner. The user may make a selection when the associated zone with indicative symbol is displayed. The size of the zone may be changeable during the display to attract the user's attention. Yet, in another embodiment, the zones are displayed one by one at the first step and then are displayed on the same screen.

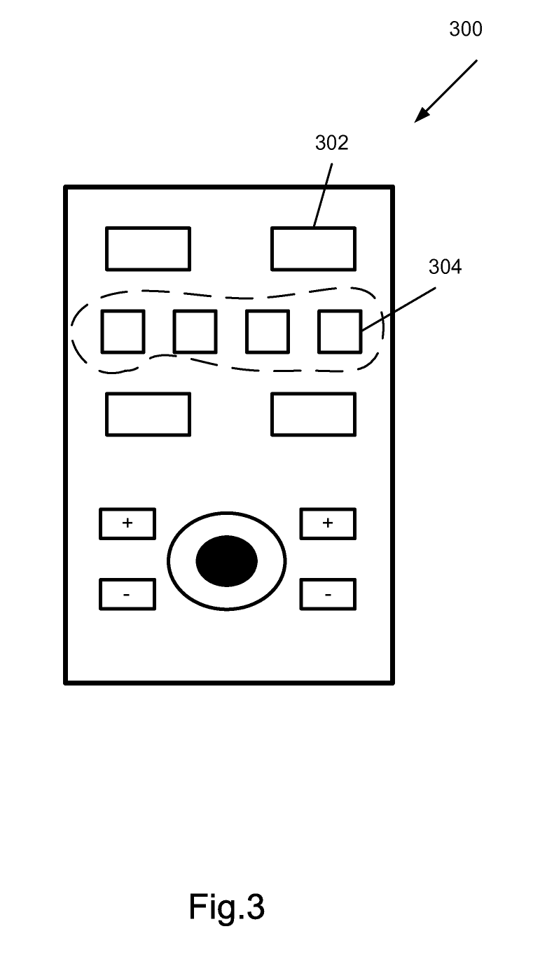

FIG. 3 is a schematic diagram of an input device, which is taken in an exemplary case as a remote control 300. The device comprises multiple buttons for receiving the user's input actions and controls the operation of the client system. The buttons are taken as an illustrating example in the present description although the extension to touch-pads and other input elements are obvious for ones familiar with the art. The button 302 is a standard switching-on button for the remote control for a television terminal. One embodiment of the present invention discloses an implementation that multiple buttons 304 are added to the remote control. Four of such buttons are shown in FIG. 3 as an illustration. The buttons are also served as switching-on buttons similar to the button 302. Each button, however, can be programmed to be associated with a specific user. For example, four members of a family can be assigned with each of four buttons. When a specific button is actuated, the client system recognizes the user associated with the button. Therefore, the user specific programming and advertisements can be rendered.

In another implementation, the buttons for channel selecting in the remote control may be used. The remote control includes a plurality of buttons for channel selection as indicated by “numbers” associated with the buttons. The button may be programmed to be associated with each user. When the television terminal is in the status of switched-off, an actuation of a specific channel selecting button switches on the television and in the same time the system recognizes the specific user associated with the button. In such an implementation, the actuation of the channel selecting button does not lead to the displaying of the selected channel programming. It leads to a switching-on screen with an advertisement. The user can make further selection of a specific channel after the displaying of the switching-on screen by using the channel selecting buttons. These buttons resumes to its normal function after the television terminal is switched on.

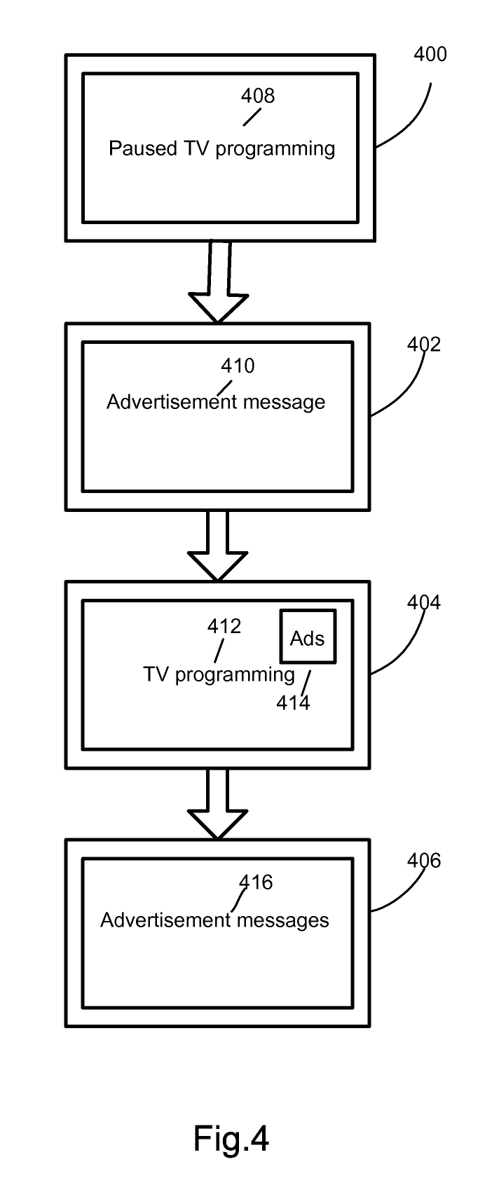

FIG. 4 is a schematic diagram of an embodiment, which renders targeted advertisements to a user by employing a paused screen of the television terminal FIG. 4 illustrates a series of changes of the television terminal from 400 to 406. The display screen 400 is the paused screen of the television terminal. A television or video programming 408 is paused when the corresponded button in the remote control is actuated. The terminal displays a screen of the programming at the point of pausing when the instruction is received. As shown in 402, the paused screen of the programming is, subsequently replaced by an advertisement 410 after the computing device recognizes the programming is paused. The user's identity was determined when the user switched on the television terminal The targeted advertisement is rendered to the user based upon the user's profile stored in the computing device.

After the user resumes the programming, typically by actuating the button for the pausing of the television one more time, the advertisement is replaced by the resumed programming 412 as shown in 404. In the same time, the displayed advertisement 410 is moved to a smaller display window 414. If the user is intrigued by the advertisement, he or she may select the advertisement in the smaller display window 414 for a further viewing as shown in 406. The operation may be achieved by moving the cursor to the smaller window and actuating the remote control. The operation may also be executed by actuating the dedicated button in the remote control. The re-displayed advertisement 416 may be in the original form of the displayed advertisement. It may also be an expanded version of the advertisement including a programming in video/audio forms for more detailed information.

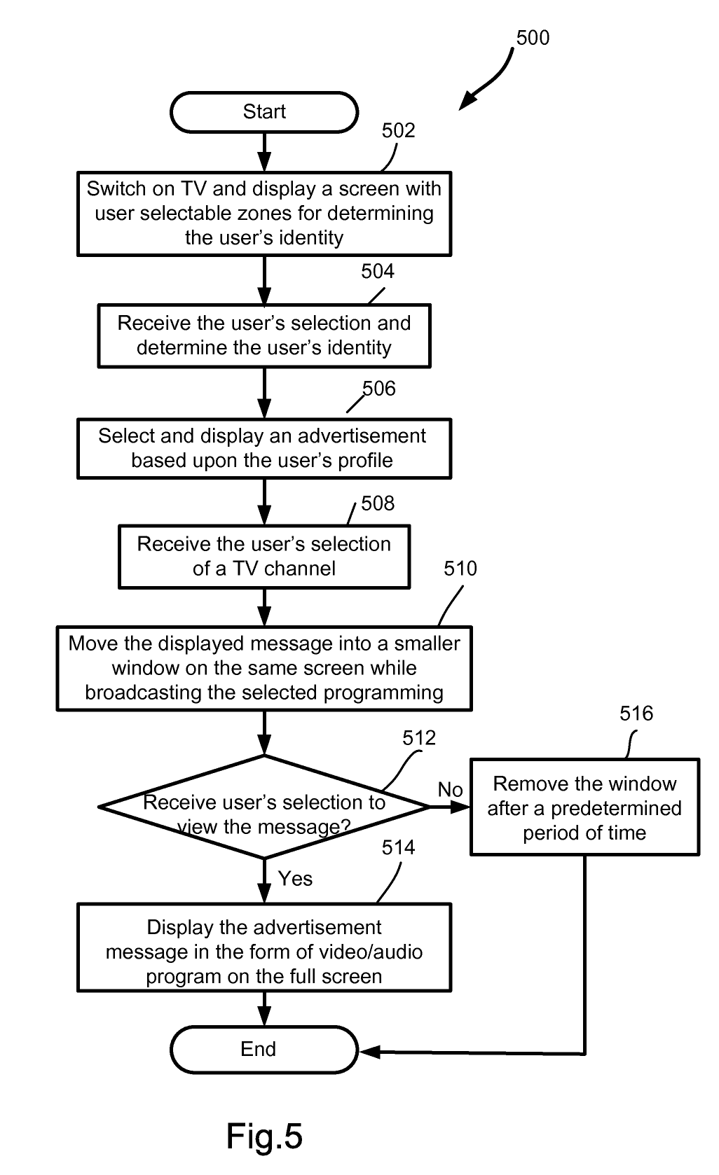

FIG. 5 is a flow diagram illustrating a process 500 that an advertisement is rendered to a user by the use of the switching-on screen of television terminal of a client system. The process starts with step 502 that the television terminal is switched on. Multiple zones are displayed on the screen. The zones are selectable by the user. Each zone is programmed to be associated with a specific user with indicative visual symbols. In step 504, the user's selection is received by the computing device and the user's identity is determined. A targeted advertisement is selected and displayed on the screen based upon the user's profile associated with the user's identity in step 506. The user's profile includes but not limits to 1) the user's personal information such as, for example, age, gender and race etc; 2) the demographic information; 3) the history of television programs the user viewed and 4) the advertisements the user selected and viewed previously.

In step 508, the client system receives the user's selection for a television channel or a video programming and replaces the screen with the selected programming. The selected programming is broadcasted while the displayed advertisement is moved into a smaller display window on the screen in the same time in step 510. The user's interest in the displayed advertisement is checked in step 512. If the user is intrigued by the advertisement, the programming is replaced by the advertisement in step 514. In one aspect, the advertisement is simply re-displayed on the screen. In another aspect, the advertisement is re-displayed with an expanded video/audio programming. If the user is not interested in the advertisement, the smaller display window containing the advertisement is removed in step 516 after a predetermined period of time.

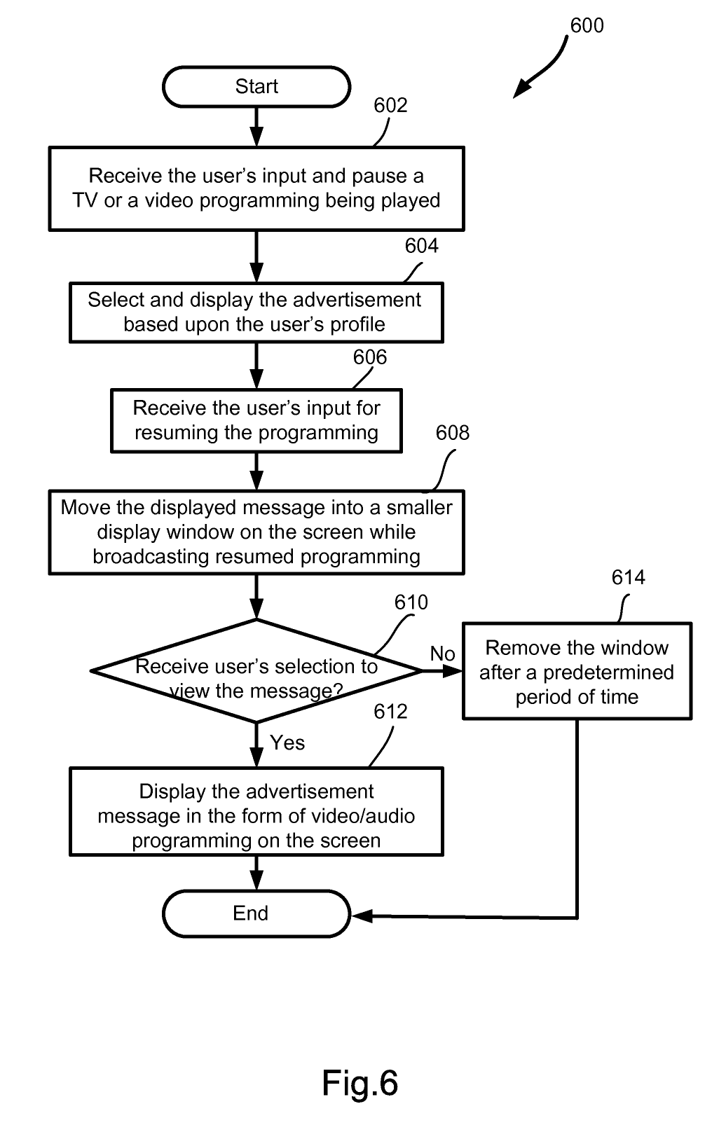

FIG. 6 is a flow diagram illustrating a process 600 that an advertisement is rendered to a user by the use of the paused screen of television terminal of a client system. The process starts with step 602 that the screen of the television terminal is paused after receiving the user's instruction through the remote control. The instruction is typically executed by the user actuating the dedicated button of the remote control. In step 604, a targeted advertisement is selected and displayed on the screen based upon the user's profile in the same manner as described previously. In step 606, the client system receives the user's instruction for resuming the television or video programming. It is typically carried out by the user re-actuating the pausing button of the remote control. The television or video programming is then re-displayed after receiving the user's instruction. The displayed advertisement is moved into a smaller display window on the screen in the same time in step 608. The user's interest in the displayed advertisement is checked in step 610. If the user is intrigued by the advertisement, the programming is replaced by the advertisement in step 612. In one aspect, the advertisement is simply re-displayed on the screen. In another aspect, the advertisement is re-displayed with an expanded video/audio programming. If the user is not interested in the advertisement, the smaller display window containing the advertisement is removed in step 614 after a predetermined period of time.

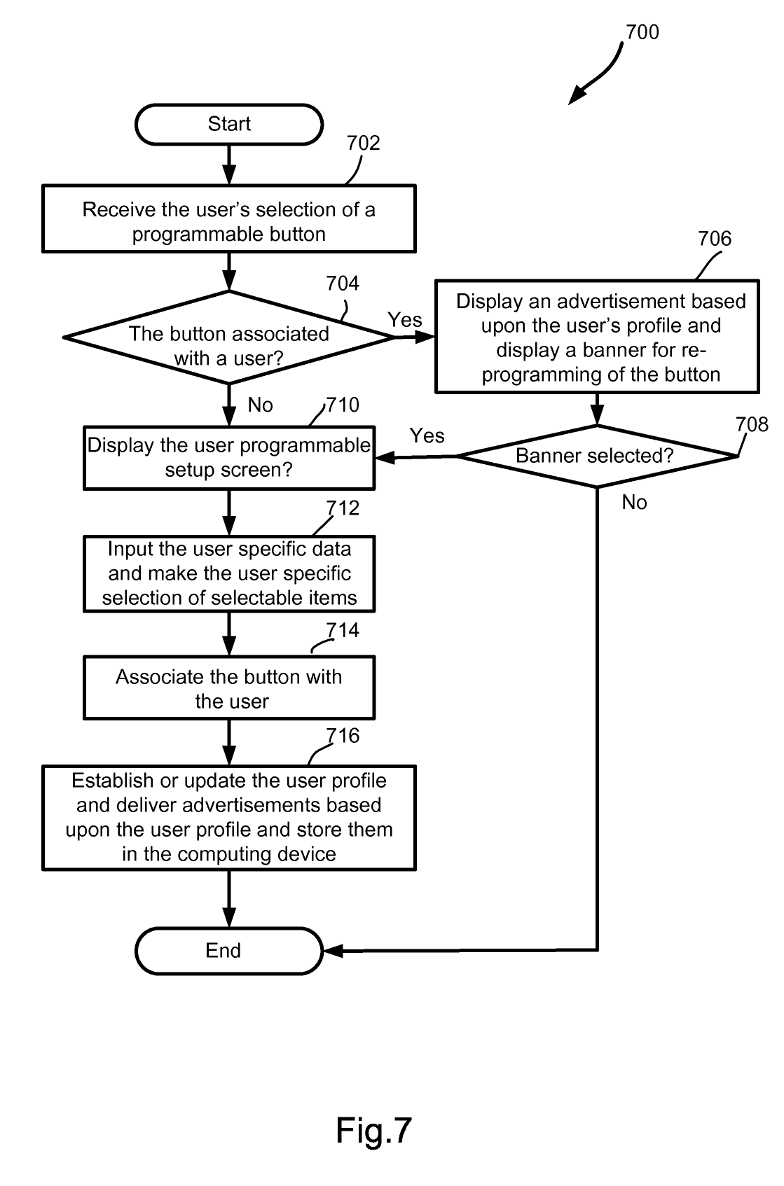

FIG. 7 is a flow diagram, illustrating a process 700 that the programmable buttons are programmed to be associated with a specific user. The process starts with step 702 that a user's selection of a programmable button is received by the computing device. In step 704, the computing device checks if the button has been associated with a user previously. If the button has been associated with a user, the computing device in step 706 interprets the user's input action as an instruction to switch on the television system. The terminal is switched on with a displayed advertisement in a manner described previously. In the same time, a visual symbol such as, for example, a banner similar to these used in web pages for displaying advertisements is displayed guiding the user to re-program the button if it is selected in step 708. If the button has not been associated with a user, the computing device controls an operation of displaying a setup screen in step 710. The setup screen may include multiple user selectable items for receiving the user's personal data in step 712. After the user completes the setup screen, the button is associated with the user by the computing device in step 714. The user profile is established or updated and a plurality of advertisements is delivered to the computing device according to the profile in step 716.

1. A method of rendering an advertisement message to a user of a television system including a television terminal, a computing device and a remote control, the method comprising:
a. associating one of numeric buttons of the remote control for channel selecting with the user by a processor of the remote control;
b. switching on the television terminal by actuating said numeric button by the user;
c. determining the user's identity by the processor of the remote control after receiving signals from the numeric button indicating that the button is being actuated; and
d. switching functionalities of the numeric buttons back for channel selecting.

2. The method as recited in claim 1, wherein said method further comprising displaying at least one advertisement message based upon a personal profile of the identified user on the screen of the television terminal.

3. The method as recited in claim 1, wherein said television system is further connectable to a server through a communication network.

4. The method as recited in claim 3, wherein said communication network further including the Internet.

5. A remote control device of a television system comprising:
a. a processor pertaining to controlling operations of the device; and
b. a plurality of numeric buttons; wherein at least one of said buttons providing a means of identifying a user and providing another means of selecting a channel after the user is identified.

6. The device as recited in claim 5, wherein said device further comprising a means of switching on the television system when said button is actuated and the user is being identified.

7. The device as recited in claim 5, wherein said television system is controlled by the remote control device and said television system renders an advertisement message to the user in a predetermine time based upon the user's personal profile after the user is identified.

8. The device as recited in claim 5, wherein said device further comprising a file storage system.
